(19) United States
(12) Patent Application Publication
(10) Pub. No.: US 2018/0259803 A1
(43) Pub. Date: Sep. 13, 2018

(54) ELECTRONIC DEVICE WITH TOUCH FUNCTION AND OPERATION METHOD THEREOF

(71) Applicant: Acer Incorporated, New Taipei City (TW)

(72) Inventors: Chia-Lun Chang, New Taipei City (TW); Chueh-Pin Ko, New Taipei City (TW)

(73) Assignee: Acer Incorporated, New Taipei City (TW)

(21) Appl. No.: 15/679,165

(22) Filed: Aug. 17, 2017

(30) Foreign Application Priority Data
Mar. 8, 2017 (TW) 106107474

(51) Int. Cl. G02F 1/1333; G06F 3/044; G06F 3/041

(52) U.S. Cl. CPC G02F 1/13338; G06F 3/0412; G06F 3/044

(57) ABSTRACT

An electronic device with touch function including a cover plate and a plurality of first sensing elements is provided. The first sensing elements are arranged in an array on an inner surface of the cover plate. Under a hovering touch mode, the first sensing elements are divided into a plurality of groups, wherein the first sensing elements in the same group are electrically connected to each other, and different groups receive a driving signal sequentially. Under a touch sensing mode, the first sensing elements receive the driving signal sequentially. Two operation methods of the electronic device with touch function are also provided.

### CROSS-REFERENCE TO RELATED APPLICATION

This application claims the priority benefit of Taiwan application serial no. 106107474, filed on Mar. 8, 2017. The entirety of the above-mentioned patent application is hereby incorporated by reference herein and made a part of this specification.

### BACKGROUND OF THE INVENTION

### 1. Field of the Invention

The present invention generally relates to an electronic device and an operation method thereof, in particular, to an electronic device with touch function and an operation method thereof.

### 2. Description of Related Art

In recent years, electronic devices with touch function are popular to customers because of easy operation and high intuition. Therefore, the electronic devices with touch function have become a main stream on the market. However, as the electronic devices with touch function were developed to have more functions, an operation method by directly touching a screen (hereinafter referred to as two-dimensional touch) has been gradually unable to meet operative demands of the customers. Therefore, providing more touch operation methods without greatly modifying the structure of the electronic devices with touch function has become one of the research focuses.

### SUMMARY OF THE INVENTION

An electronic device with touch function and a plurality of operation methods of the electronic device with touch function are provided in the invention.

The electronic device with touch function of the invention includes a cover plate and a plurality of first sensing elements. The first sensing elements are arranged in an array on an inner surface of the cover plate. The first sensing elements are divided into a plurality of groups under a hovering touch mode, wherein the first sensing elements in the same group are electrically connected to each other, and difference groups receive a driving signal sequentially. The first sensing elements receive the driving signal sequentially under a touch sensing mode.

In an embodiment of the invention, the electronic device with touch function further includes a plurality of second sensing elements. The second sensing elements and the first sensing elements are located at the same side of the cover plate, and the second sensing elements are disposed in a peripheral region of the first sensing elements. The second sensing elements respectively perform a mutual capacitance sensing with a corresponding group among the groups under the hovering touch mode.

In an embodiment of the invention, the second sensing elements and the first sensing elements are disposed on the inner surface of the cover plate together.

In an embodiment of the invention, the electronic device with touch function further includes a display module and a metal frame. The metal frame has a recess to accommodate the display module. The display module is located in the recess and located between the first sensing elements and the metal frame. An adjustable interval exists between the second sensing elements and the metal frame, and the second sensing elements receive the driving signal sequentially under a pressure sensing mode.

In an embodiment of the invention, the groups respectively perform self capacitance sensing under the hovering touch mode, and the first sensing elements respectively perform self capacitance sensing under the touch sensing mode.

In an embodiment of the invention, the electronic device with touch function further includes a display module, a pressure sensor and a frame structure. The frame structure has a recess to accommodate the display module and the pressure sensor. The display module and the pressure sensor are located in the recess, and the display module is located between the first sensing elements and the pressure sensor.

An operation method of an electronic device with touch function of the invention includes the following steps. An electronic device with touch function is provided. A hovering touch mode of the electronic device with touch function is enabled. Self-capacitance values of a plurality of hovering touch elements of the electronic device with touch function are detected to determine whether the self capacitance value of any of the hovering touch elements is greater than a pre-determined maximum value. If the self capacitance value of one of the hovering touch elements is greater than the pre-determined maximum value, then the hovering touch mode is switched to a touch sensing mode. Self capacitance values of a plurality of touch sensing elements of the electronic device with touch function are detected to determine whether the self capacitance value of any of the hovering touch elements is lower than a pre-determined minimum value. If the self capacitance value of one of the touch sensing elements is lower than the pre-determined minimum value, then whether a time period in which the self capacitance value is lower than the pre-determined minimum value reaches a pre-determined time period is determined. If the time period in which the self capacitance value is lower than the pre-determined minimum value reaches the pre-determined time period, then the touch sensing mode is switched to the hovering touch mode.

In an embodiment of the invention, the operation method of the electronic device with touch function further includes the following steps. A pressure sensing mode of the electronic device with touch function is not enabled when the hovering touch mode is enabled. The pressure sensing mode is enabled while the hovering touch mode is switched to the touch sensing mode. The pressure sensing mode is not enabled while the touch sensing mode is switched to the hovering touch mode.

An operation method of an electronic device with touch function of the invention includes the following steps. An electronic device with touch function is provided. A hovering touch mode of the electronic device with touch function is enabled. Mutual capacitance values of a plurality of hovering touch elements are detected to determine whether the mutual capacitance value of one of the hovering touch elements is lower than a pre-determined first minimum value. If the mutual capacitance value of one of the touch sensing elements is lower than the pre-determined first minimum value, then the hovering touch mode is switched to the touch sensing mode. Self capacitance values of a plurality of touch sensing elements of the electronic device with touch function are detected to determine whether the self capacitance value of one of the touch sensing elements is lower than a pre-determined second minimum value. If the self capacitance value of one of the touch sensing elements is lower than the pre-determined second minimum value, then whether a time period in which the self capacitance value is lower than the pre-determined second minimum value reaches a pre-determined time period is detected. If the time period in which the self capacitance value is lower than the pre-determined second minimum value reaches the pre-determined time period, then the touch sensing mode is switched to the hovering touch mode.

In an embodiment of the invention, the operation method of the electronic device with touch function further includes the following steps. A pressure sensing mode of the electronic device with touch function is not enabled when the hovering touch mode is enabled. The pressure sensing mode is enabled while the hovering touch mode is switched to the touch sensing mode. The pressure sensing mode is not enabled while the touch sensing mode is switched to the hovering touch mode.

In view of the above, in the embodiments of the invention, the electronic device with touch function may provide a hovering touch function and a touch sensing (two-dimensional touch) function by disposing the first sensing elements. In other words, in addition to the two-dimensional sensing, the electronic device with touch function also provides users to perform touch operations by approaching, but not contacting, the electronic device with touch function. For example, the electronic device with touch function can be applied to determine positions or gestures of a touch object (e.g., a stylus, a finger or so forth).

In order to make the aforementioned and other features and advantages of the invention comprehensible, embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic cross-sectional view illustrating an electronic device with touch function according to an embodiment of the invention.

FIG. 2A is a schematic top view illustrating a cover plate, first sensing elements and second sensing elements shown in FIG. 1.

FIG. 2B is a schematic top view illustrating an equivalent configuration of the first sensing elements shown in FIG. 2A under a hovering touch mode.

FIG. 3A and FIG. 3B are respectively schematic cross-sectional views, and illustrate a variation of an adjustable interval between a second sensing element and a metal frame under a pressure.

FIG. 4 is a schematic flow chart illustrating an operation method of the electronic device with touch function shown in FIG. 1.

FIG. 5 is a schematic cross-sectional view illustrating an electronic device with touch function according to another embodiment of the invention.

FIG. 6A is a schematic top view illustrating a cover plate and first sensing elements shown in FIG. 5.

FIG. 6B is a schematic top view illustrating an equivalent configuration of the first sensing elements shown in FIG. 6A under a hovering touch mode.

FIG. 7 is a schematic flow chart illustrating an operation method of the electronic device with touch function shown in FIG. 5.

### DESCRIPTION OF THE EMBODIMENTS

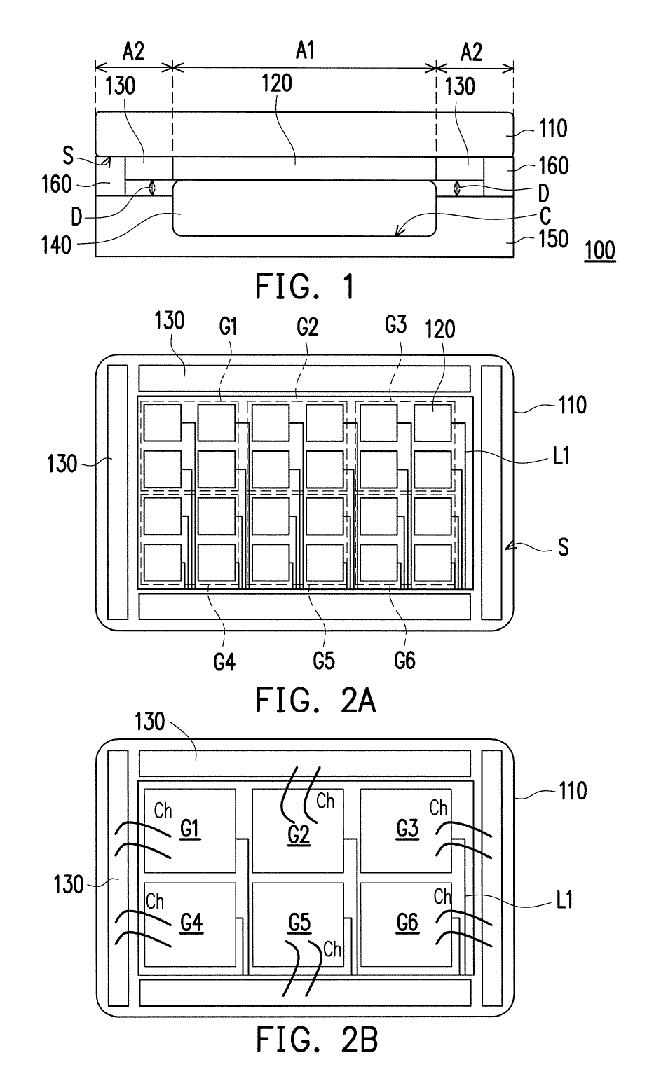

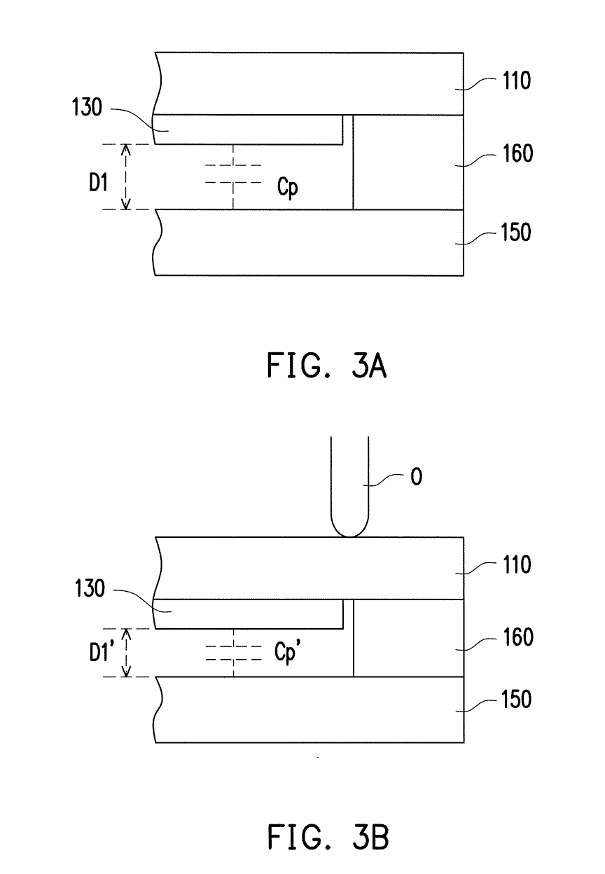

FIG. 1 is a schematic cross-sectional view illustrating an electronic device with touch function according to an embodiment of the invention. FIG. 2A is a schematic top view illustrating a cover plate, first sensing elements and second sensing elements shown in FIG. 1. FIG. 2B is a schematic top view illustrating an equivalent configuration of the first sensing elements shown in FIG. 2A under a hovering touch mode. FIG. 3A and FIG. 3B are respectively schematic cross-sectional views, and illustrate a variation of an adjustable interval between a second sensing element and a metal frame under a pressure.

Referring to FIG. 1 through FIG. 3B, an electronic device with touch function 100 of the present embodiment includes a cover plate 110 and a plurality of first sensing elements 120. The first sensing elements 120 are arranged in an array on an inner surface S of the cover plate 110. The first sensing elements 120 are disposed in correspondence with a display area A1 of the electronic device with touch function 100. Therefore, the first sensing elements 120 adopt electrodes that allow light to pass through, so as to possess a great light transmittance. The electrodes allowing light to pass through may be transparent electrodes or metal mesh electrodes. A material of the transparent electrodes may include metal oxide, but the invention is not limited thereto. The electronic device with touch function 100 may further include a plurality of first conductive lines L1. The first conductive lines L1 are respectively and electrically connected with one of the first sensing elements 120, so as to transmit signals.

In the present embodiment, the electronic device with touch function 100 may further include a plurality of second sensing elements 130. The second sensing elements 130 and the first sensing elements 120 are located at the same side of the cover plate 110, and the second sensing elements 130 are disposed in a peripheral region of the first sensing elements 120. As shown in FIG. 2A, the second sensing elements 130 may be disposed at four outer sides of the first sensing elements 120. However, an amount and a distribution of the second sensing elements 130 may be altered according to requirements, and should not be limited to the illustration of FIG. 2A.

The second sensing elements 130 are disposed in correspondence with a peripheral trace area A2 of the electronic device with touch function 100. Thus, the second sensing elements 130 not only can adopt the electrodes that allows light to pass through but also can adopt opaque electrodes, such as metal electrodes. In addition, the second sensing elements 130 and the first sensing elements 120 may be disposed on the inner surface S of the cover plate 110 together. Alternatively, the second sensing elements 130 may be disposed on a substrate, then bonded to the inner surface S of the cover plate 110. The electronic device with touch function 100 may further include a plurality of second conductive lines (not shown). The second conductive lines are respectively and electrically connected with one of the second sensing elements 130, so as to transmit signals.

In the present embodiment, the electronic device with touch function 100 may further include a display module 140 and a metal frame 150. The display module 140 is disposed in correspondence with the display area A1, and suitable for providing a display function. The display module 140 may be a display module of any type. For instance, the display module 140 may be a liquid crystal display module including a backlight module and a liquid crystal display panel, but the invention is not limited thereto.

The metal frame 150 has a recess C, so as to accommodate the display module 140. The display module 140 is located in the recess C and located between the first sensing elements 120 and the metal frame 150. An adjustable interval D is existed between the second sensing elements 130 and the metal frame 150. The electronic device with touch function 100 may further include a compressible elastomer 160. The compressible elastomer 160 is located between the cover plate 110 and the metal frame 150. For example, a material of the compressible elastomer 160 may be a dielectric material. In an embodiment, the compressible elastomer 160 may be omitted.

By disposing the first sensing elements 120, the second sensing elements 130 and the metal frame 150, the electronic device with touch function 100 of the present embodiment can have a hovering touch mode, a touch sensing mode and a pressure sensing mode.

Under the hovering touch mode, the first sensing elements 120 may be served as driving electrodes, and the second sensing elements 130 may be served as sensing electrodes. The first sensing elements 120 are divided into a plurality of groups (e.g., groups G1 through G6), wherein the first sensing elements 120 in the same group are electrically connected to each other, and different groups receive a driving signal sequentially. A method of electrically connecting the first sensing elements 120 in the same group is such as controlling on and off states of switches located between a chip and the first sensing elements 120, such that the driving signal output from the chip can be transmitted to each of the sensing elements 120 in the same group at one time. The second sensing elements 130 respectively perform a mutual capacitance sensing with a corresponding group among the groups. As shown in FIG. 2B, there is a mutual capacitance value Ch between each group and the corresponding second sensing element 130. When a conductive object approaches, the mutual capacitance value Ch decreases correspondingly. In another aspect, when the conductive object moves from the top of the group G1 to the top of the group G3, the mutual capacitance values Ch of the corresponding groups G1 through G3 decrease sequentially. As a result, the electronic device with touch function 100 is capable of detecting positions and gestures of the conductive object thereabove by disposing the first sensing elements 120 and the second sensing elements 130.

The first sensing elements 120 may respectively perform self capacitance sensing under a touch sensing mode. In other words, the first sensing elements 120 are not be divide into groups, and receive the driving signal sequentially under the touch sensing mode.

As shown in FIG. 3A and FIG. 3B, under a pressure sensing mode, the second sensing elements 130 may receive the driving signal sequentially, and the metal frame 150 may be served as a ground electrode (ground sensor) under the pressure sensing mode. A distance between the second sensing elements 130 and the metal frame 150 decreases when the touch object O presses the electronic device with touch function 100. For instance, the distance D1 between the second sensing elements 130 and the metal frame 150 becomes a distance D1′, and the distance D1′ is less than the distance D1, such that a capacitance value between the second sensing elements 130 and the metal frame 150 increases. For instance, the capacitance value Cp between the second sensing elements 130 and the metal frame 150 becomes a capacitance value Cp′, and the capacitance value Cp′ is greater than the capacitance value Cp. The greater decreased amount of the distance results in the greater variation amount of the capacitance value. Thus, a pressure variation can be obtained based on the variation of the capacitance value.

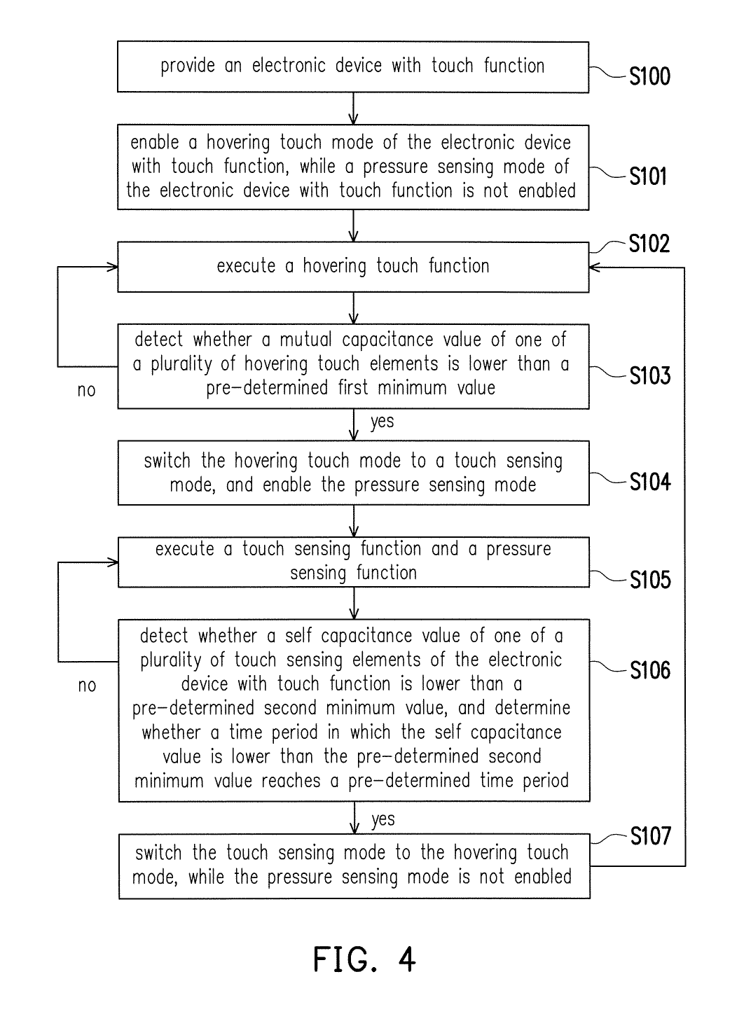

FIG. 4 is a schematic flow chart illustrating an operation method of the electronic device with touch function shown in FIG. 1. Referring FIG. 1 through FIG. 4, an operation method of the electronic device with touch function 100 may include the following steps. Firstly, the electronic device with touch function 100 is provided (step S100). Afterward, the hovering touch mode of the electronic device with touch function 100 is enabled (step S101), so as to execute a hovering touch function (step S102). The hovering touch mode is enabled by switching the switches between a chip (not illustrated) and the first sensing elements 120, such that the driving signal output from the chip can be transmitted to each of the groups sequentially. A sensing signal is then transmitted to the chip via second conductive lines (not shown) connected with the second sensing elements 130, so as to perform hovering touch sensing. In the present embodiment, the pressure sensing mode of the electronic device with touch function 100 may not be enabled when the hovering touch mode is enabled, in order to save power.

Subsequently, whether a mutual capacitance value of one of a plurality of hovering touch elements of the electronic device with touch function 100 (refers to a mutual capacitance value between the group and the second sensing element 130) is lower than a pre-determined first minimum value is detected (step S103). If the mutual capacitance value of one of the hovering touch elements is lower than the pre-determined first minimum vale, then the hovering touch mode may be switched to the touch sensing mode (step S104). On the other hand, if the mutual capacitance value of any one of the hovering touch elements is not lower than the pre-determined first minimum value, then the hovering touch function is kept executing (step S102). Switching to the touch sensing mode is executed, for example, by switching the switches between the chip (not shown) and the first sensing elements 120, such that the driving signal output from the chip can be transmitted to each of the first sensing elements 120 sequentially.

In the present embodiment, the pressure sensing mode may be enabled while the hovering touch mode is switched to the touch sensing mode, so as to execute a touch sensing function and a pressure sensing function (step S105). The enablement of the pressure sensing mode may include, for example, transmitting the driving signal to the second sensing elements 130 sequentially.

Thereafter, whether a self capacitance value of one of a plurality of touch sensing elements of the electronic device with touch function 100 (a self capacitance value of one of the first sensing elements 120) is lower than a pre-determined second minimum value is detected, and whether a time period in which the self capacitance value is lower than the pre-determined second minimum value reaches a pre-determined time period is determined (step S106). If the self capacitance value of one of the touch sensing elements is lower than the pre-determined second minimum value (which refers to a situation that the touch object is away from the electronic device with touch function 100) and the time period in which the self capacitance value is lower than the pre-determined second minimum reaches the pre-determined time period, then the touch sensing mode is switched to the hovering touch mode, and the pressure sensing mode is not enabled (step S107). On the other hand, if the self capacitance value of one of the touch sensing elements is not lower than the pre-determined second minimum value, or the time period in which the self capacitance value is lower than the pre-determined second minimum value does not reach the pre-determined time period, then the function of touch sensing is kept executing (step S105).

By virtue of the determination mechanism regarding the pre-determined first minimum value and the pre-determined second minimum value, the electronic device with touch function 100 can be switched between the hovering touch mode and the touch sensing mode automatically. That is, users may not need to switch touch modes manually, but the invention is not limited thereto. In addition, the touch object touches the electronic device with touch function 100 intermittently when performing a two-dimensional touch operation. That is, a time interval exists between two consecutive touches. Therefore, by virtue of the determination mechanism regarding the pre-determined time period, switching the electronic device with touch function 100 from the touch sensing mode to the hovering touch mode in the time interval between two touches can be avoided. In other words, continuously switching the electronic device with touch function 100 between the hovering touch mode and the touch sensing mode can be avoided. The length of the pre-determined time period may be altered according to requirements. For instance, the pre-determined time period is 2 seconds, but the invention is not limited thereto.

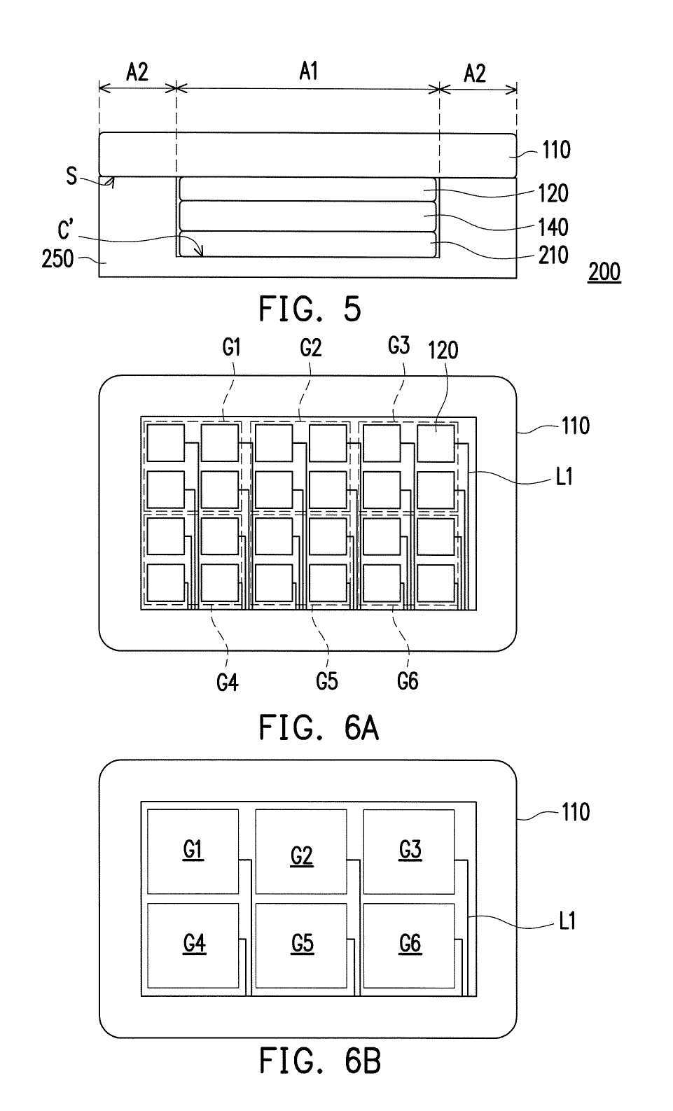

FIG. 5 is a schematic cross-sectional view illustrating an electronic device with touch function according to another embodiment of the invention. FIG. 6A is a schematic top view illustrating a cover plate and first sensing elements shown in FIG. 5. FIG. 6B is a schematic top view illustrating an equivalent configuration of the first sensing elements shown in FIG. 6A under a hovering touch mode.

Referring to FIG. 5 through FIG. 6B, an electronic device with touch function 200 of the present embodiment is similar with the electronic device with touch function 100 shown in FIG. 1 through FIG. 2B. The same numeral or similar numerals in the electronic device with touch function 200 and the electronic device with touch function 100 refer(s) to the same element or similar elements. A relative disposition relationship or an effect of the same element would not be repeated again in the following description.

Major differences between the electronic device with touch function 200 and the electronic device with touch function 100 are stated in the following description. The second sensing elements 130, the metal frame 150 and the compressible elastomer 160 shown in FIG. 1A are omitted in the electronic device with touch function 200. In addition, the electronic device with touch function 200 further includes a pressure sensor 210 and a frame structure 250. The pressure sensor 210 is applied to sense pressure, and the pressure sensor 210 may be a pressure sensor of any type, such as a piezoresistive-type pressure sensor, an inductance-type pressure sensor, a capacitance-type pressure sensor or so forth, but the invention is not limited thereto.

The frame structure 250 has a recess C′, so as to accommodate the display module 140 and the pressure sensor 210. The display module 140 and the pressure sensor 210 are located in the recess C′, and the display module 140 is located between the first sensing elements 120 and the pressure sensor 210.

In the electronic device with touch function 100, the metal frame 150 is served as a ground electrode under the pressure sensing mode, thus the metal frame 150 is required to consist of a conductive material. In the present embodiment, an external pressure can be sensed by the pressure sensor 210, such that the frame structure 250 may not be required to consist of a conductive material.

By disposing the first sensing elements 120 and the pressure sensor 210, the electronic device with touch function 200 of the present embodiment can have the hovering touch mode, the touch sensing mode and the pressure sensing mode.

The first sensing elements 120 are also divided into a plurality of groups (such as groups G1 through G6) under the hovering touch mode, wherein the first sensing elements 120 in the same group are electrically connected with each other, and different groups respectively perform self capacitance sensing. The first sensing elements 120 respectively perform self capacitance sensing under the touch sensing mode. Under the pressure sensing mode, the pressure sensor 210 can perform pressure sensing according to variations of piezoresistance, inductance or capacitance, but the invention is not limited thereto.

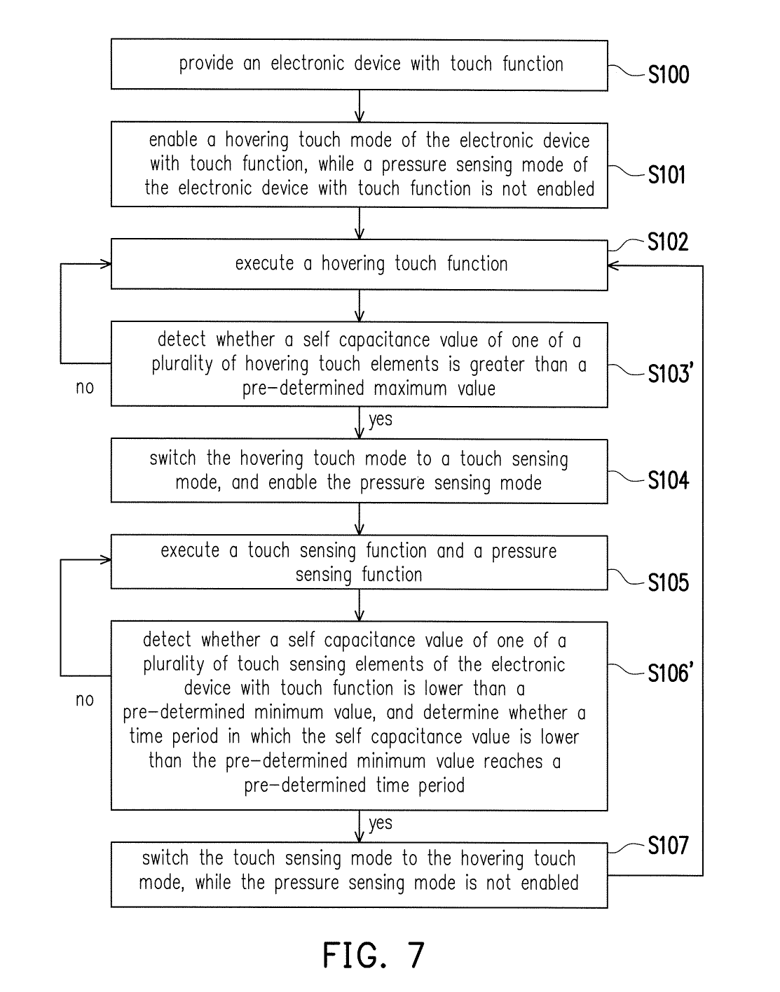

FIG. 7 is a schematic flow chart illustrating an operation method of the electronic device with touch function shown in FIG. 5. Referring to FIG. 5 through FIG. 7, an operation method of the electronic device with touch function 200 is similar with the operation method of the electronic device with touch function 100 shown in FIG. 4. The description of the same step or similar steps can be referred to the previous paragraphs, and would not be repeated herein.

Major differences between the operation methods of the electronic device with touch function 200 and the electronic device with touch function 100 include: in a step S103′, the proximity between a touch object and the electronic device with touch function 200 is determined by detecting whether the self capacitance value of one of the hovering touch elements of the electronic device with touch function 200 (refers to the self capacitance value of one of the groups G1 through G6) is greater than a pre-determined maximum value. When the self capacitance value of one of the hovering touch elements is greater than the pre-determined maximum value, the touch object is very close to the electronic device with touch function 200, then the hovering touch mode may be switched to the touch sensing mode (step S104). On the other hand, if the self capacitance value of any one of the hovering touch elements is not greater than the pre-determined maximum value, then the function of hovering touch is kept executing (step S102).

It should be further noted that, the pre-determined minimum value in the step S106′ shown in FIG. 7 may be equal to the pre-determined second minimum value in the step S106 shown in FIG. 4.

Based on the foregoing, in the electronic devices with touch function of the embodiments of the invention, the hovering touch function and the touch sensing function can be provided by disposing the first sensing elements. In an embodiment, the pressure sensing function can be further provided by disposing the second sensing elements or the pressure sensor. Moreover, in the operation methods of the electronic devices with touch function of the embodiments of the invention, the electronic devices with touch function can be switched between the hovering touch mode and the touch sensing mode automatically by the determination mechanism regarding the pre-determined value. Furthermore, the electronic devices with touch function can be avoided from switching from the touch sensing mode to the hovering touch mode in the time interval between two consecutive touches by the determination mechanism regarding the pre-determined time period.

Although the present invention has been disclosed by the exemplary embodiments described above, they are not applied to limit the scope of the present invention. It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An electronic device with touch function, comprising:
a cover plate; and
a plurality of first sensing elements, arranged in an array on an inner surface of the cover plate, wherein,
under a hovering touch mode, the first sensing elements are divided into a plurality of groups, wherein the first sensing elements in the same group are electrically connected to each other, and difference groups receive a driving signal sequentially;
under a touch sensing mode, the first sensing elements receive the driving signal sequentially.

2. The electronic device with touch function according to claim 1, further comprising a plurality of second sensing elements, wherein the second sensing elements and the first sensing elements are located at the same side of the cover plate, and the second sensing elements are disposed in a peripheral region of the first sensing elements, wherein the second sensing elements respectively perform a mutual capacitance sensing with a corresponding group among the groups under the hovering touch mode.

3. The electronic device with touch function according to claim 2, wherein the second sensing elements and the first sensing elements are disposed on the inner surface of the cover plate together.

4. The electronic device with touch function according to claim 2, further comprising a display module and a metal frame, wherein the metal frame has a recess to accommodate the display module, the display module is located in the recess and located between the first sensing elements and the metal frame, wherein an adjustable interval exists between the second sensing elements and the metal frame, and the second sensing elements receive the driving signal sequentially under a pressure sensing mode.

5. The electronic device with touch function according to claim 1, wherein the groups respectively perform self capacitance sensing under the hovering touch mode, and the first sensing elements respectively perform self capacitance sensing under the touch sensing mode.

6. The electronic device with touch function according to claim 5, further comprising a display module, a pressure sensor and a frame structure, wherein the frame structure has a recess to accommodate the display module and the pressure sensor, the display module and the pressure sensor are located in the recess, and the display module is located between the first sensing elements and the pressure sensor.

7. An operation method of an electronic device with touch function, comprising:
providing an electronic device with touch function;
enabling a hovering touch mode of the electronic device with touch function;
detecting whether a self capacitance value of one of a plurality of hovering touch elements of the electronic device with touch function is greater than a pre-determined maximum value;
if the self capacitance value of one of the hovering touch elements is greater than the pre-determined maximum value, then switching the hovering touch mode to a touch sensing mode;
detecting whether a self capacitance value of one of a plurality of touch sensing elements of the electronic device with touch function is lower than a pre-determined minimum value;
if the self capacitance value of one of the touch sensing elements is lower than the pre-determined minimum value, then determining whether a time period in which the self capacitance value is lower than the pre-determined minimum value reaches a pre-determined time period;
if the time period in which the self capacitance value is lower than the pre-determined minimum value reaches the pre-determined time period, then switching the touch sensing mode to the hovering touch mode.

8. The operation method of the electronic device with touch function according to claim 7, further comprising:
not enabling a pressure sensing mode of the electronic device with touch function when the hovering touch mode is enabled;
enabling the pressure sensing mode while switching the hovering touch mode to the touch sensing mode; and
not enabling the pressure sensing mode while switching the touch sensing mode to the hovering touch mode.

9. An operation method of an electronic device with touch function, comprising:
providing an electronic device with touch function;
enabling a hovering touch mode of the electronic device with touch function;
detecting whether a mutual capacitance value of one of a plurality of hovering touch elements is lower than a pre-determined first minimum value;
if the mutual capacitance value of one of the hovering touch elements is lower than the pre-determined first minimum value, then switching the hovering touch mode to a touch sensing mode;
detecting whether a self capacitance value of one of a plurality of touch sensing elements of the electronic device with touch function is lower than a pre-determined second minimum value;
if the self capacitance value of one of the touch sensing elements is lower than the pre-determined second minimum value, then determining whether a time period in which the self capacitance value is lower than the pre-determined second minimum value reaches a pre-determined time period;
if the time period in which the self capacitance value is lower than the pre-determined second minimum value reaches the pre-determined time period, then switching the touch sensing mode to the hovering touch mode.

10. The operation method of the electronic device with touch function according to claim 9, further comprising:
not enabling a pressure sensing mode of the electronic device with touch function when the hovering touch mode is enabled;
enabling the pressure sensing mode while switching the hovering touch mode to the touch sensing mode; and
not enabling the pressure sensing mode while switching the touch sensing mode to the hovering touch mode.
